(19) United States
(12) Patent Application Publication
(10) Pub. No.: US 2023/0386194 A1
(43) Pub. Date: Nov. 30, 2023

(54) SYSTEM AND METHOD FOR ON DEVICE EDGE LEARNING

(71) Applicant: ALPHAICS INDIA PVT. LTD, BANGALORE (IN)

(72) Inventors: Sooraj Kovoor Chathoth, BANGALORE (IN); SHIVAM GARG, FARIDABAD (IN)

(21) Appl. No.: 18/295,792

(22) Filed: Apr. 4, 2023

(30) Foreign Application Priority Data
May 27, 2022 (IN) 202241030405

(51) Int. Cl. G06V 10/82; G06V 10/776; G06V 10/77

(52) U.S. Cl. CPC G06V 10/82; G06V 10/776; G06V 10/7715

(57) ABSTRACT

A method and a system for device edge learning is disclosed. The method includes training an artificial intelligence (AI) model for extracting the visual embeddings with pre-trained visual deployment networks; checking the performance of AI model by feeding real-time data and by performing an inference; initiating an edge learning; extracting visual embeddings with pre-trained visual deployment networks; performing the inference and adding a text image embedding; taking the text embeddings using text embedders embeddings; converting the text to image embeddings to generate augmented image embeddings and adding text embeddings; training learning networks on a plurality of agents; and performing forward prop with the mapping networks and calculating the loss and backprop.

### CROSS-REFERENCE TO RELATED APPLICATION

The Application claims the priority of the Indian Provisional Patent Application numbered 202241030405 filed on 27 May 2022 with the Title “SYSTEM AND METHOD FOR ON DEVICE EDGE LEARNING”, and contents of which are included entirely as reference here.

### BACKGROUND

### Technical Field

The embodiments herein generally relate to the field of edge devices. More particularly, the embodiments herein relate to a method and a system for on device edge learning.

### Description of the Related Art

Typically, handling artificial intelligence (AI) inference workloads at edge devices close to where the data is created is desirable. Examples of handling workloads on edge devices include for example, autonomous car vision systems and surveillance cameras. The time between analysis and action (latency) is reduced when workloads are handled at the edge, which is critical for many applications. In order to rely on datacenter resources for inference tasks, the communication links are required to have low latency, predictability, and dependability. Generally, the above-mentioned characteristics cannot be supported by cloud resources. Furthermore, there are numerous situations in which a data privacy is critical and transmitting sensitive data to a public cloud platform is not a choice. Apart from the data privacy and latency, reliance on leased cloud resources for inference will result in a higher cost. Aside from the data privacy and latency, relying on leased cloud resources for inference will incur a recurrent operational expense that most cost-sensitive edge applications cannot afford. It costs money to have enough processing resources to handle inference at the edge devices. The additional burden will inevitably affect the cost, size, and power dissipation of the edge device. Embedded electronics, which are very sensitive to pricing and power waste, bear the brunt of this load. Supporting training tasks at the edge would necessitate more resources than inference, and AI edge processors are not equipped to do so.

While most of the systems focuses on optimizing inference on edge devices some prior methods focus more on transfer learning and fine-tuning based approaches, both are computationally expensive for the edge device and are less accurate and do not solve the problem completely. Typically, federated learning is used to train the AI models present on edge, but they too require a cloud connectivity and hence not truly edge learning. While other approaches are mostly utilizing the high precision, floating model using servers and are based on standard software aspects and are very limited in configuring the learning. Hence there is need for a method and a system that requires a central cloud learning system in place.

The above-mentioned shortcomings, disadvantages and problems are addressed herein, and which will be understood by reading and studying the following specification.

### OBJECTS OF THE INVENTION

The primary object of the embodiments herein is to provide a system and method for on device edge learning.

Another object of the embodiments herein is to provide incremental learning and updating the parameters of a network doing inside the edge device without the help of an extern cloud server.

Yet another object of the embodiments herein is to provide a system that learns to update its parameters under varying learning modes and predominantly uses low precision, low power arithmetic without relying on retraining.

Yet another object of the embodiments herein is to provide the hardware aspects of the edge and are configurable to make use of the data from different modularities.

Yet another object of the embodiments herein is to provide the deployment networks that are the main inference networks and are fixed in parameters and follow a typical inference pipeline and generally encode the data and have been trained offline on fixed categories of data.

Yet another object of the embodiments herein is to provide a mode of learning that are the modes that signal the system to start edge learning. One can either provide the data manually or it can be done automatically by the system itself.

Yet another object of the embodiments herein is to provide learning networks that is the part of the system which is learnable, and these are the networks that adapts to the unseen part of the data by mapping them with the data extracted from other modularites like text.

Yet another object of the embodiments herein to perform neural networks inference on low power edge devices while adapting to new unseen, changing data distribution without retraining from scratch.

Yet another object of the embodiments herein is to provide processors with low power ratings and can be used for continually learning and updating the model on the fly after deploying.

Yet another object of the embodiments herein is to perform full integer only continual learning so can be used in full integer only hardwares without the need of retraining.

Yet another object of the embodiments herein is to provide applications that need to learn on the fly after deployment without retraining the inference network from scratch using cloud servers. It alleviates privacy concerns, network and bandwidth related issues and is ideal for deployment in remote locations and under the sea, inside the body etc.

These and other objects and advantages will become more apparent when reference is made to the following description and accompanying drawings.

### SUMMARY

This summary is provided to introduce a selection of concepts in a simplified form that are further disclosed in the detailed description. This summary is not intended to determine the scope of the claimed subject matter.

In an aspect a method for device edge learning is provided. The method comprises the steps of training an artificial intelligence (AI) model for extracting the visual embeddings with pre-trained visual deployment networks; checking the performance of AI model by feeding realtime data and by performing an inference; initiating an edge learning, and wherein the edge learning refers to an ability of a device to perform inference on items that are not part of an initial training dataset, and the edge learning is performed in the background without interfering with the inference. The method further includes extracting visual embeddings with pre-trained visual deployment networks; performing the inference and adding a text image embedding upon obtaining a last layer and an intermediate layer as outputs of inference; taking the text embeddings using text embedders embeddings; converting the text to image embeddings to generate augmented image embeddings and adding text embeddings; and training learning networks on a plurality of agents. The learning networks are adaptable to unseen part of data by mapping with data extracted from other modularities.

According to an embodiment, the method further includes performing forward prop with the mapping networks and calculating the loss and backprop.

According to an embodiment, extracting visual embeddings includes taking the visual part of embeddings from seen classes for calculating loss. The method further includes extracting the visual embeddings with pre-trained visual deployment networks. The pre-trained visual deployment networks are divided into the pre-trained networks and semi-supervised networks. The method further includes providing the real-time feed to the pre-trained visual deployment networks and the feed displays stock quotes and their respective real-time changes, with a very insignificant lag time. The method further includes extracting the image embeddings including a last layer and an intermediate layer. The method further includes providing one of the real time feeds from different point of view or augmented feed to a semi-supervised network and extracting the image embeddings including the last layer and the intermediate layer.

According to an embodiment, the performing inference further includes computing a dot product of embedding and output vector for doing a maximum of inference.

The method further includes determining an equivalent class/output and obtaining an ensemble of a plurality of outputs.

According to an embodiment, taking text embeddings using text embedders embeddings further includes taking the text embeddings using text embedders embeddings. The process is performed by using at least one of glove embeddings, word to vector embeddings, fast text embeddings and attribute embeddings.

According to an embodiment, the method further includes augmenting the text embeddings using one of synonyms if present or by using regex-based text inducers.

According to an embodiment, converting the text to image embeddings further includes converting the pretrained text to image minimalist model trained on minimum context data from unseen images.

According to an embodiment, performing forward prop with the mapping networks further includes performing forward prop with mapping network. The method further includes offloading a first learning network to an agent. The method further includes offloading as second learning network to the agent. The method further includes offloading a third learning network to the agent. The method further includes extracting the features via a graph convolution network (GCN) and offloading a fourth learning network to the agent.

According to an embodiment, calculating loss and backprop further includes calculating the loss based on the equation:

Loss=Z(data_positive)−H(metadata_positive)−lambda*(Z(data_negative)−H(metadata_negative)),
where data_positive i input data of same class from different camera point of view, metadata is an input metadata of different class from different/same cameras, Z is embedding, and H is the learning network.

The method further includes checking the model. The method further includes calculating contrastive loss and sync gradients from a plurality of agents upon the model being float. The method further includes calculating regression against the image embeddings at (x). The method further includes quantizing the embeddings present in (x) using minimalistic data upon the model being int. The method further includes performing regression against the quantized image. The method further includes calculating loss and sync gradients from the plurality of agents. The method further includes converting weights and biases to integers. The method further includes replacing the softmax with integer softmax and replacing contrastive loss with pseudo contrastive loss.

In another aspect a system for on device edge learning is provided. The system includes a memory for storing one or more executable modules and a processor for executing the one or more executable modules for device edge learning. The one or more executable modules includes a training module for training an artificial intelligence (AI) model for extracting the visual embeddings with pre-trained visual deployment networks. The one or more executable modules further includes a checking module for checking the performance of AI model by feeding realtime data and by performing an inference. The one or more executable modules further includes an edge learning module for initiating an edge learning. The edge learning refers to an ability of a device to perform inference on items that are not part of an initial training dataset, and the edge learning is performed in the background without interfering with the inference. The one or more executable modules further includes a visual embedding extraction module for extracting visual embeddings with pre-trained visual deployment networks. The one or more executable modules further includes an inference module for performing the inference and adding a text image embedding upon obtaining a last layer and an intermediate layer as outputs of inference, taking the text embeddings using text embedders embeddings, converting the text to image embeddings to generate augmented image embeddings and adding text embeddings, training learning networks on a plurality of agents. The learning networks are adaptable to unseen part of data by mapping with data extracted from other modularities and performing forward prop with the mapping networks and calculating the loss and backprop.

According to an embodiment, the visual embeddings extraction module is further configured for taking the visual part of embeddings from seen classes for calculating loss, extracting the visual embeddings with pre-trained visual deployment networks, the pre-trained visual deployment networks are divided into the pre-trained networks and semi-supervised networks, providing the real-time feed to the pre-trained visual deployment networks and the feed displays stock quotes and their respective real-time changes, with a very insignificant lag time, extracting the image embeddings including a last layer and an intermediate layer, providing one of the real time feed from different point of view or augmented feed, to a semi-supervised network and extracting the image embeddings including the last layer and the intermediate layer.

According to an embodiment, the inference module is further configured for computing a dot product of embedding and output vector for doing a maximum of inference. The interference is calculated based on the equation:

Y(data)=Weight_matrix(data)·Z(data).

The inference module is further configured for determining an equivalent class/output and obtaining an ensemble of a plurality of outputs.

According to an embodiment, the inference module if further configured for taking the text embeddings using text embedders embeddings and the process is performed by using at least one of glove embeddings, word to vector embeddings, fast text embeddings and attribute embeddings.

According to an embodiment, the inference module is further configured for augmenting the text embeddings using one of synonyms if present or by using regex-based text inducers.

According to an embodiment, the inference module is further configured for converting the pretrained text to image minimalist model trained on minimum context data from unseen images.

According to an embodiment, the inference module is further configured for performing forward prop with mapping network, offloading a first learning network to an agent, offloading as second learning network to the agent, offloading a third learning network to the agent, extracting the features via a graph convolution network (GCN) and offloading a fourth learning network to the agent.

According to an embodiment, calculating loss and backprop further includes calculating the loss based on the equation:

Loss=Z(data_positive)−H(metadata_positive)−lambda*(Z(data_negative)−H(metadata_negative))
where data_positive is input data of same class from different camera POV metadata is an input metadata of different class from different/same cameras, Z is embedding, and H is the learning network.

The calculating loss and backprop further includes checking the model, calculating contrastive loss and sync gradients from a plurality of agents upon the model being float, calculating regression against the image embeddings at (x), quantizing the embeddings present in (x) using minimalistic data upon the model being int, performing regression against the quantized image, calculating loss and sync gradients from the plurality of agents, converting weights and biases to integers, replacing the softmax with integer softmax and replacing contrastive loss with pseudo contrastive loss.

### BRIEF DESCRIPTION OF THE DRAWINGS

The other objects, features and advantages will occur to those skilled in the art from the following description of the preferred embodiment and the accompanying drawings in which:

FIG. 1A is a block diagram of a system for device edge learning, in accordance with an embodiment;

FIG. 1B illustrates an architecture of the system for device edge learning, in accordance with an embodiment;

FIGS. 2A-2C illustrates a flowchart of method for device edge learning, in accordance with an embodiment herein;

FIG. 3 illustrates a flowchart of extracting visual embeddings with pre-trained visual deployment networks, in accordance with an embodiment herein;

FIG. 4 illustrates a flowchart of performing inference, in accordance with an embodiment herein;

FIG. 5 illustrates a flowchart for taking text embeddings using text embedders embeddings, in accordance with an embodiment herein;

FIG. 6 illustrates a flowchart for augmenting text embeddings, in accordance with an embodiment herein;

FIG. 7 illustrates a flowchart for augmenting image embeddings, in accordance with an embodiment herein;

FIG. 8 illustrates a flowchart for performing forward prop with the mapping networks, in accordance with an embodiment herein;

FIG. 9 illustrates a flowchart for calculating loss and backprop, in accordance with an embodiment herein; and

FIG. 10 is a flow diagram illustrating the method for device edge learning, in accordance with an embodiment.

Although the specific features of the embodiments herein are shown in some drawings and not in others. This is done for convenience only as each feature may be combined with any or all of the other features in accordance with the embodiments herein.

### DETAILED DESCRIPTION OF THE DRAWINGS

The detailed description of various exemplary embodiments of the disclosure is described herein with reference to the accompanying drawings. It should be noted that the embodiments are described herein in such details as to clearly communicate the disclosure. However, the amount of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the disclosure.

The embodiments herein provide a system and method for device edge learning. The system provides incremental learning and updating the parameters of a network doing inside the edge device without the help of an extern cloud server.

According to one embodiment herein, a system performs neural networks inference on low power edge devices while adapting to new unseen, changing data distribution without retraining from scratch. In an embodiment the system provides processors with low power ratings and can be used for continually learning and updating the model on the fly after deploying.

As used herein the term “edge learning” refers to ability of a device to perform inference on items that were not part of its initial training dataset. In some ways, this may be considered as the device's ability to retrain itself locally based on new unseen images without relying on cloud resources. This must be done continually, in the background, and without interfering with the device's primary inference function. Consider using an AI-enabled inspection camera on a manufacturing line to identify product types. Modern systems are excellent at identifying products on which they have been trained, but they will be unable to distinguish freshly introduced products. Manufacturers can instantly adapt their systems to cover new goods with edge learning, avoiding the requirement for brand new cloud training. Such a scenario is common, and systems that can support edge learning will result in significant operational costs.

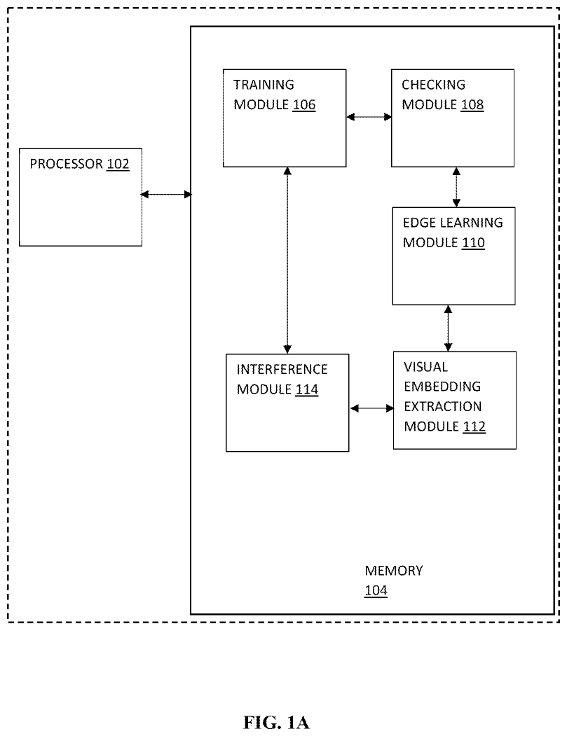

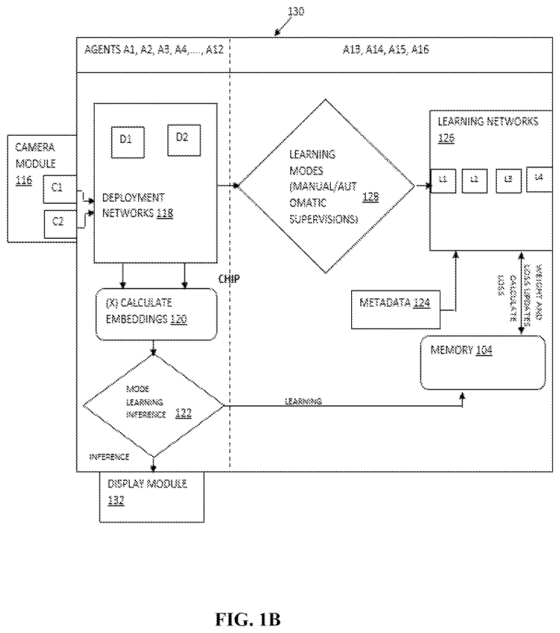

FIG. 1A depicts a system for device edge learning, in accordance with an embodiment. The system 100 includes:
a memory 102 for storing one or more executable modules; and
a processor 104 for executing the one or more executable modules for device edge learning, the one or more executable modules comprising:
   a training module 106 for training an artificial intelligence (AI) model for extracting the visual embeddings with pre-trained visual deployment networks;
   a checking module 108 for checking the performance of AI model by feeding real-time data and by performing an inference;
   an edge learning module 110 for initiating an edge learning, wherein the edge learning refers to an ability of a device to perform inference on items that are not part of an initial training dataset and wherein the edge learning is performed in the background without interfering with the inference;
   a visual embedding extraction module 112 for extracting visual embeddings with pre-trained visual deployment networks; and
   an inference module 114 for:
      performing the inference and adding a text image embedding upon obtaining a last layer and an intermediate layer as outputs of inference;
      taking the text embeddings using text embedders embeddings;
      converting the text to image embeddings to generate augmented image embeddings and adding text embeddings;
      training learning networks on a plurality of agents, wherein the learning networks are adaptable to unseen part of data by mapping with data extracted from other modularities; and
      performing forward prop with the mapping networks and calculating the loss and backprop.

The processor 104 refers to any one or more microprocessors, central processing unit (CPU) devices, finite state machines, computers, microcontrollers, digital signal processors, logic, a logic device, an application specific integrated circuit (ASIC), a field-programmable gate array (FPGA), a chip, and the like or any combination thereof, capable of executing computer programs or a series of commands, instructions, or state transitions.

The system 100 is configured to perform incremental learning and updating the parameters of a network doing inside the edge device without the help of an extern cloud server. The system 100 learns to update its parameters under varying learning modes and predominantly uses low precision, low power arithmetic without relying on retraining. While other existing approaches mostly utilize the high precision, floating model using servers and are based on standard software aspects and are very limited in configuring the learning, the present system 100 utilizes the hardware aspects of the edge and are configurable also make use of the data from different modularity.

The system 100 is useful for processors with low power ratings and can be used for continually learning and updating the model on the fly after deploying. Also, the system 100 is useful for applications that need to learn on the fly after deployment without retraining the inference network from scratch using cloud servers. It alleviates privacy concerns, network and bandwidth related issues and is ideal for deployment in remote locations and under the sea, inside the body, and the like.

The training module 106 is configured for training an artificial intelligence (AI) model for extracting the visual embeddings with pre-trained visual deployment networks. The checking module 108 is configured for checking the performance of AI model by feeding realtime data and by performing an inference. In an embodiment, for performing inference, the checking module 108 computes a dot product of embedding and output vector for doing a maximum of inference. The interference is calculated based on the equation (1):

Y(data)=Weight_matrix(data)·Z(data) (1)

The checking module 108 determines an equivalent class/output and obtains an ensemble of a plurality of outputs.

The edge learning module 110 is configured for initiating an edge learning. The edge learning refers to an ability of a device to perform inference on items that are not part of an initial training dataset and wherein the edge learning is performed in the background without interfering with the inference.

The visual embedding extraction module 112 extracts visual embeddings with pretrained visual deployment networks. In an embodiment, the visual embedding extraction module 112 takes the visual part of embeddings from seen classes for calculating loss and extracts the visual embeddings with pre-trained visual deployment networks, where the pre-trained visual deployment networks are divided into the pre-trained networks and semi-supervised networks. Further, the visual embedding extraction module 112 provides the real-time feed to the pre-trained visual deployment networks and the feed displays stock quotes and their respective real-time changes, with a very insignificant lag time.

The visual embedding extraction module 112 extracts the image embeddings comprising a last layer and an intermediate layer. The visual embedding extraction module 112 provides one of: the real time feed from different point of view or augmented feed to a semi-supervised network. The visual embedding extraction module 112 extracts the image embeddings comprising the last layer and the intermediate layer.

The inference module 114 is configured for performing the inference and adding a text image embedding upon obtaining a last layer and an intermediate layer as outputs of inference and taking the text embeddings using text embedders embeddings. In an embodiment, the text embeddings are taken by using at least one of: glove embeddings, word to vector embeddings, fast text embeddings and attribute embeddings. The inference module 114 is configured for converting the text to image embeddings to generate augmented image embeddings and adding text embeddings and training learning networks on a plurality of agents. The learning networks are adaptable to unseen part of data by mapping with data extracted from other modularities. The inference module 114 is configured for converting the text to image by converting the pretrained text to image minimalist model trained on minimum context data from unseen images.

The inference module 114 is configured for performing forward prop with the mapping networks and calculating the loss and backprop. In an embodiment, the system 100 augments the text embeddings using one of: synonyms if present or by using regex-based text inducers.

In an embodiment, performing forward prop with the mapping networks further comprises performing forward prop with mapping network, offloading a first learning network to an agent, offloading as second learning network to the agent, offloading a third learning network to the agent, extracting the features via a graph convolution network (GCN), and offloading a fourth learning network to the agent. In an embodiment, calculating loss and backprop includes calculating the loss based on the equation (2):

Loss=Z(data_positive)−H(metadata_positive)−lambda*(Z(data_negative)−H(metadata_negative)) (2)
where data_positive is input data of same class from different camera POV, metadata is an input metadata of different class from different/same cameras, Z is embedding, and H is the learning network.

Calculating loss and backprop further includes checking the model, calculating contrastive loss and sync gradients from a plurality of agents upon the model being float, calculating regression against the image embeddings at (x), quantizing the embeddings present in (x) using minimalistic data upon the model being int, performing regression against the quantized image, calculating loss and sync gradients from the plurality of agents, converting weights and biases to integers, replacing the softmax with integer softmax, and replacing contrastive loss with pseudo contrastive loss.

FIG. 1B depicts an architecture diagram of the system 100 for on device edge learning, in accordance with an embodiment. The architecture consists of mainly five parts including camera module 116, deployment networks 118, calculate embeddings 120, mode learning/inference 122, metadata 124, learning networks 126, and learning module 128. The camera module 116 (C1 and C2) is an AI-enabled inspection camera on a manufacturing line to identify product types. The deployment networks 118 are the main inference networks and are generally fixed in parameters and follow a typical inference pipeline and generally encode the data and have been trained offline on fixed categories of data. The deployment networks 118 serve as the foundation for extracting features from data (say an image). The deployment networks 118 are designed to get optimum feature representation of objects that are invariant to environmental changes and also make use of self-supervision. To obtain features for the unseen classes of data, the deployment networks 118 employ self-supervised generalized knowledge. The feature vectors (embeddings) obtained here are then used with learning networks 126 to perform categorization of previously unseen classes. The deployment networks 118 are good classifiers in and of themselves, but they cannot work directly with unseen data. These generalizing networks are deployment on the edge exploiting model parallelism and hence tied to various hardware agents of the processor. Based on the complexity of these networks the hardware resources can be configured to meet real time needs. Further, augmenter is used to give the learning phase a better priority to start. It is done by using a fixed model to map the data from one domain to another and the output of this part severs as a start for the learning network. This step also has a regularizing effect on the system 100 as well. The present technology generalizes the feature mapping and helps us to learn over time when unseen data arrive at a later time.

The embeddings are calculated using equation (3):

Z(Data)=F(Data)+G(Metadata) (3)

Where Data=input data let's say camera feed, Metadata=Meta data Corresponding to input data, Z=Embedding, G=Prior Network, and F=Deployment Network

The metadata 124 is the information apart from image of object. As in textual or signal information of the object. Generally, this information is already presented with the training dataset itself. For example: “Horse on a grassland” is the metadata of the corresponding data (image). In some embodiments, the metadata 124 is generated as well from the class label as well. For example: A photo of a horse. For some classes it can be possible that the system is only present with Meta information like only textual information is present. The information will be the input to prior network. For some classes we can have a graph of relationships between the classes like Animal (root node)->Mammal (intermediate node)->Human (Leaf node). The graph information may be used as the input for GCN.

The leaning modes 128 are the modes that signal the system to start edge learning. One can either provide the data manually or it can be done automatically by the system 100 itself. There are two learning modes 128 including a manual mode and an automatic mode. In the manual model, the user provides supervision for some new/unseen classes and the transfer learning can be performed with the last layer of embedder itself and the mapping network is trained accordingly. In the automatic mode, the network learns to associate the given new/unseen classes with the already existing text information. This is similar to Semi supervised mode where the system automatically distinguishes between the same new classes as different from training one and combined with the mapping network. The label of the object is predicted.

The learning networks 126 are part of the system that is learnable. These are the networks that adapt to the unseen part of the data by mapping them with the data extracted from other modularites like text. The visual part of embeddings are taken from the seen classes for calculating the loss. The seen classes are the classes/categories that were present in the training dataset or the ones that are provided by the manual supervision. The loss function used here is contrastive distance metric loss which is same as classification task. It is used to help learn the three fully connected models, so they can learn to map the embeddings to visual features of deployment network. The loss is calculated by the following equation (4):

Loss=Z(data_positive)−H(metadata_positive)−lambda*(Z(data_negative)−H(metadata_negative)) (4)
Where Data_positive=input data of same class from different camera POV
Metadata=input Metadata of different class from different/same cameras
Z=embedding
H=Learning Network

In an embodiment, for computing maximum of inference dot product of embedding and output vector is taken. The interference is calculated by following equation (5):

Y(data)=Weight_matrix(data)·Z(data) (5)

The agents 130 (A1-A16) are responsible for instantiating modules, ensuring that they continue to run, and reporting the status of modules back to internet of things (IoT) hub. The display module 132 is a highly integrated real-time embedded system that is tuned to efficiently interact and communicate with its environment.

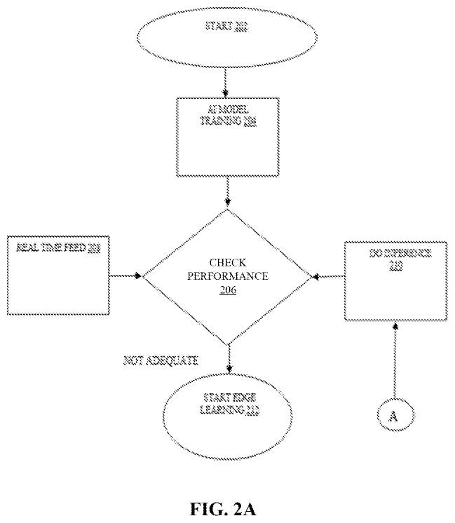

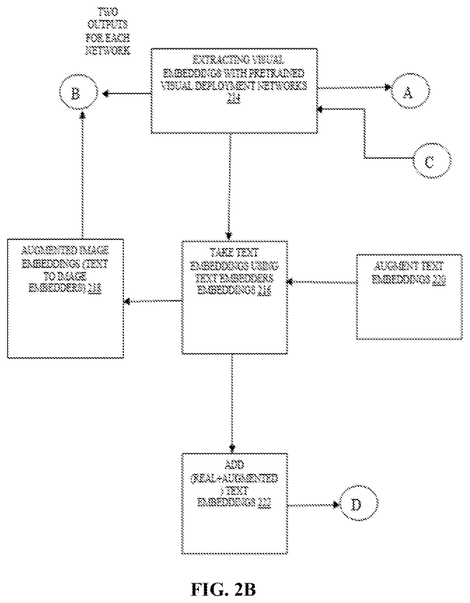

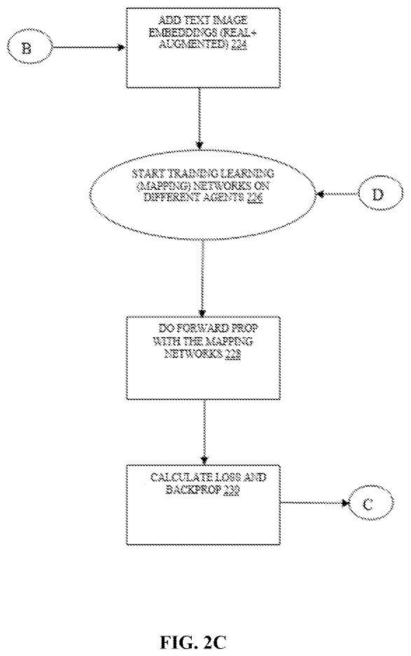

FIG. 2A-2C depicts a flowchart of method for device edge learning, in accordance with an embodiment. There are seven main steps in this method. At step 202, the method starts. At step 204, the AI model is trained. At step 206, the performance of AI model is checked by feeding real-time 208 data and by performing the inference 210. At step 212, edge learning is started. The edge learning refers to ability of a device to perform inference on items that were not part of its initial training dataset. In some ways, this may be considered as the device's ability to retrain itself locally based on new unseen images without relying on cloud resources. The edge learning must be done continually, in the background, and without interfering with the primary inference function of the device. At step 214, the visual embeddings are extracted with pre-trained visual deployment networks. There are two outputs for each network, including a last layer and an intermediate layer. Subsequently, the inference is performed again by repeating steps 210. If the two layers are obtained at step 214, a text image embedding is added (real+augmented) at step 224. At step 216, the text embeddings using text embedders embeddings in taken. The input provided to this process is augment text embeddings 220. The output of this process at step 218, is augmented image embeddings where the text is converted to image embeddings. At step 222, (real+augmented) text embeddings are added. At step 226, the learning (mappings) networks are trained on different agents. This part of the system is learnable these are the networks that adapts to the unseen part of the data by mapping them with the data extracted from other modularites like text. At step 228, forward prop is performed with the mapping networks. At step 230, the loss and backprop is calculated.

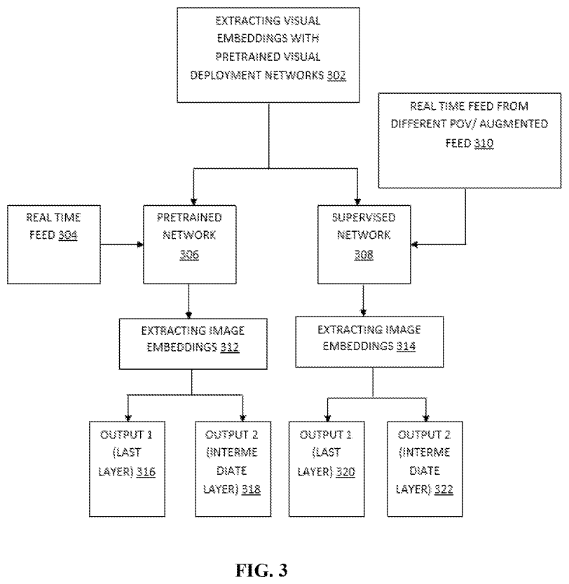

FIG. 3 depicts a flowchart of extracting visual embeddings with pre-trained visual deployment networks, in accordance with an embodiment. The visual part of embeddings are taken from the seen classes for only calculating loss. At step 302, the visual embeddings are extracted with pre-trained visual deployment networks. These networks are divided into the pre-trained networks 306 and semi-supervised networks 308. At step 304, the real-time feed is provided to the pre-trained network where the feed displays stock quotes and their respective real-time changes, with a very insignificant lag time. At step 312, the image embeddings are extracted. There are two outputs for this step 312. The outputs are output1 that is last layer 316 and output2 that is intermediate layer 318. At step 310, the real time feed from different point of view or augmented feed is provided to semi-supervised network. At step 314, the image embeddings are extracted. There are two outputs for this process. The outputs are output1 that is last layer 320 and output2 that is intermediate layer 322.

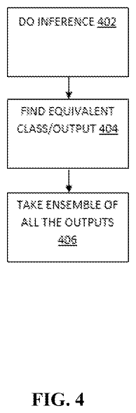

FIG. 4 depicts a flowchart of a method of performing inference, in accordance with an embodiment. At step 402, the inference is initiated. For doing maximum of Inference dot product of embedding and output vector is taken. The interference is calculated by following equation (6):

Y(data)=Weight_matrix(data)·Z(data) (6)

At step 404, the equivalent class/output is found. At step 406, the ensemble of all the outputs are obtained.

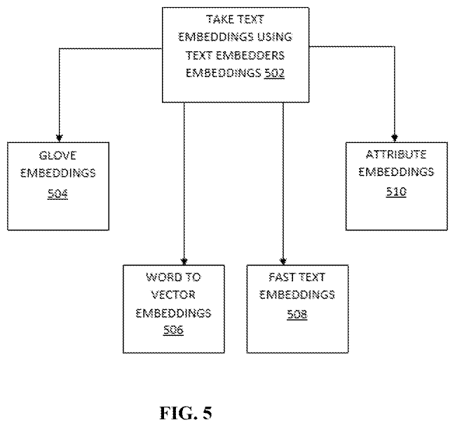

FIG. 5 depicts a flowchart for taking text embeddings using text embedders embeddings, in accordance with an embodiment. At step 502, the text embeddings using text embedders embeddings are taken. This process is performed by using glove embeddings 504, word to vector embeddings 506, fast text embeddings 508 and attribute embeddings 510.

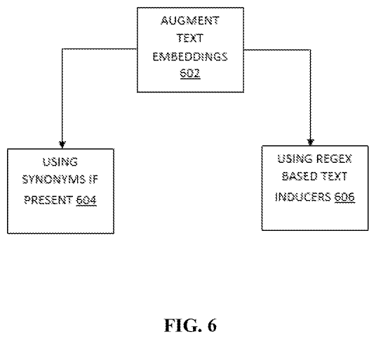

FIG. 6 depicts a flowchart for augmenting text embeddings, in accordance with an embodiment. At step 602, the text embeddings are augmented. This process is performed by using synonyms 604 if present or by using regex-based text inducers 606.

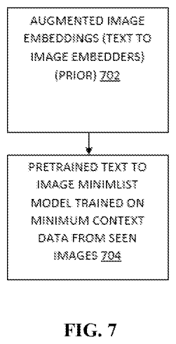

FIG. 7 depicts a flowchart for augmenting image embeddings, in accordance with an embodiment. At step 702, the image embeddings are augmented. The augmenting image embeddings is the process of converting the text to image embedded. At step 704, the pre-trained text is converted to image minimalist model trained on minimum context data from unseen images.

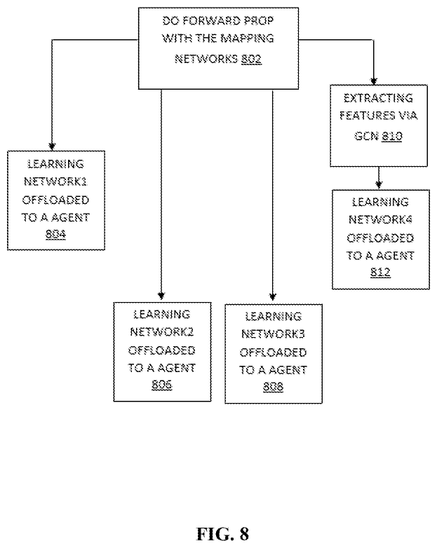

FIG. 8 depicts a flowchart for performing forward prop with the mapping networks, in accordance with an embodiment. At step 802, forward prop is performed with mapping network. At step 804, the learning network 1 is offloaded to an agent. At step 806, the learning network 2 is offloaded to the agent. At step 808, the learning network 3 is offloaded to the agent. At step 810, the features are extracted via Graph convolution network (GCN). GCN is used for extracting features from non-Euclidian structures like graphs/trees. This particularly is useful when a graph of relationships between the classes is present as the features can be extracted from them. At step 812, the learning network 4 is offloaded to the agent. The learning networks are part of the system that is learnable. These are the networks that adapts to the unseen part of the data by mapping them with the data extracted from other modularites like text. The steps involved in performing forward prop with mapping networks involves first the embedder used to predict the output. If the output is below some defined threshold, then the mapping network will take embeddings from the (embedding network+prior network). Then the softmax is calculated and output is predicted.

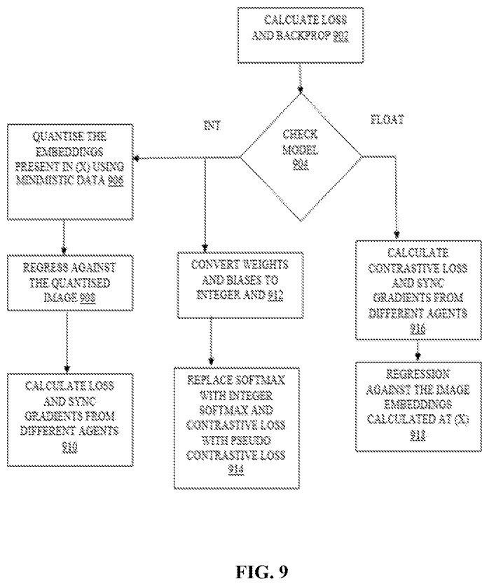

FIG. 9 depicts a flowchart for calculating loss and backprop, in accordance with an embodiment. At step 902, the process to calculate loss and backprop is initiated. At step 904, the model is checked. If the model is float then at step 916, contrastive loss and sync gradients from different agents are calculated. At step 918, regression against the image embeddings calculated at (x). In this way if the model is int then at step 906, the embeddings present in (x) using minimalistic data is quantized. At step 908, regression is performed against the quantized image. At step 910, loss and sync gradients are calculated from different agents. At step 912, weights and biases are converted to integers. At step 914, the SoftMax is replaced with integer SoftMax, and contrastive loss is replaced with pseudo contrastive loss. Then step 910 is continued.

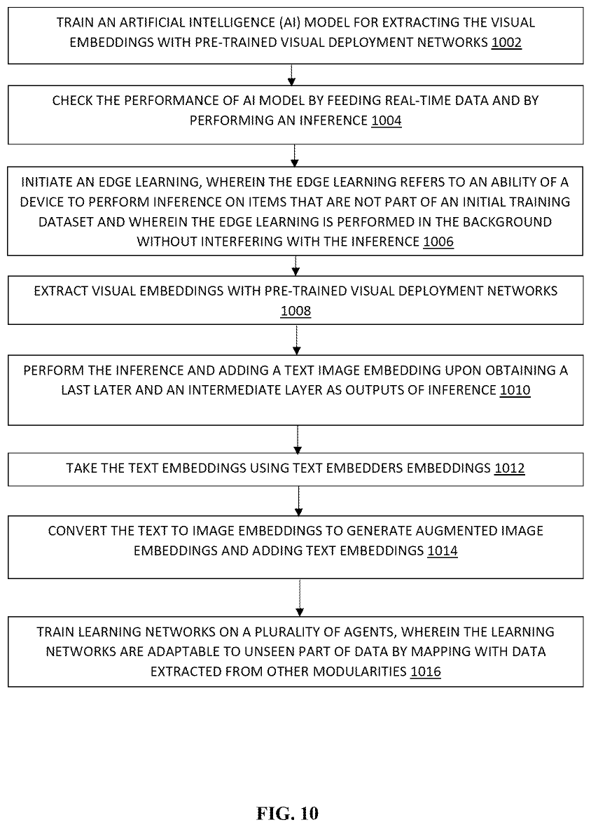

FIG. 10 depicts a flow diagram illustrating a method for device edge learning. At step 1002, the method includes training an artificial intelligence (AI) model for extracting the visual embeddings with pre-trained visual deployment networks. At step 1004, the method includes checking the performance of AI model by feeding real-time data and by performing an inference. At step 1006, the method includes initiating an edge learning, wherein the edge learning refers to an ability of a device to perform inference on items that are not part of an initial training dataset. The edge learning is performed in the background without interfering with the inference. At step 1008, the method includes extracting visual embeddings with pre-trained visual deployment networks. At step 1010, the method includes performing the inference and adding a text image embedding upon obtaining a last layer and an intermediate layer as outputs of inference. At step 1012, the method includes taking the text embeddings using text embedders embeddings. At step 1014, the method includes converting the text to image embeddings to generate augmented image embeddings and adding text embeddings. At step 1016, the method includes training learning networks on a plurality of agents. The learning networks are adaptable to unseen part of data by mapping with data extracted from other modularities. The method further includes performing forward prop with the mapping networks and calculating the loss and backprop.

According to an embodiment, extracting visual embeddings includes taking the visual part of embeddings from seen classes for calculating loss. The method further includes extracting the visual embeddings with pre-trained visual deployment networks. The pre-trained visual deployment networks are divided into the pre-trained networks and semi-supervised networks. The method further includes providing the real-time feed to the pre-trained visual deployment networks and the feed displays stock quotes and their respective real-time changes, with a very insignificant lag time. The method further includes extracting the image embeddings including a last layer and an intermediate layer. The method further includes providing one of the real time feeds from different point of view or augmented feed to a semi-supervised network and extracting the image embeddings including the last layer and the intermediate layer.

According to an embodiment, the performing inference further includes computing a dot product of embedding and output vector for doing a maximum of inference. The interference is calculated based on the equation:

Y(data)=Weight_matrix(data)·Z(data).

The method further includes determining an equivalent class/output and obtaining an ensemble of a plurality of outputs.

According to an embodiment, taking text embeddings using text embedders embeddings further includes taking the text embeddings using text embedders embeddings. The process is performed by using at least one of glove embeddings, word to vector embeddings, fast text embeddings and attribute embeddings.

According to an embodiment, the method further includes augmenting the text embeddings using one of synonyms if present or by using regex-based text inducers.

According to an embodiment, converting the text to image embeddings further includes converting the pretrained text to image minimalist model trained on minimum context data from unseen images.

According to an embodiment, performing forward prop with the mapping networks further includes performing forward prop with mapping network. The method further includes offloading a first learning network to an agent. The method further includes offloading as second learning network to the agent. The method further includes offloading a third learning network to the agent. The method further includes extracting the features via a graph convolution network (GCN) and offloading a fourth learning network to the agent.

According to an embodiment, calculating loss and backprop further includes calculating the loss based on the equation:

Loss=Z(data_positive)−H(metadata_positive)−lambda*(Z(data_negative)−H(metadata_negative)),
where data_positive is input data of same class from different camera point of view, metadata is an input metadata of different class from different/same cameras, Z is embedding, and H is the learning network.

The method further includes checking the model. The method further includes calculating contrastive loss and sync gradients from a plurality of agents upon the model being float. The method further includes calculating regression against the image embeddings at (x). The method further includes quantizing the embeddings present in (x) using minimalistic data upon the model being int. The method further includes performing regression against the quantized image. The method further includes calculating loss and sync gradients from the plurality of agents. The method further includes converting weights and biases to integers. The method further includes replacing the softmax with integer softmax and replacing contrastive loss with pseudo contrastive loss.

The various embodiments of the present technology can be used for applications that need to learn on the fly after deployment without retraining the inference network from scratch using cloud servers. It alleviates privacy concerns, network and bandwidth related issues and is ideal for deployment in remote locations and under the sea, inside the body etc.

The embodiments herein provide a system and method that can perform full integer only continual learning so can be used in full integer only hardwares without the need of retraining. All are operations require 8 bits or very rarely 32 bits for calculating some metrics so also its highly memory efficient. The present technology does not go through any issues like connectivity, bandwidth, and privacy issues. Additionally, the present technology perform neural networks inference on low power edge devices while adapting to new unseen, changing data distribution without retraining from scratch. Moreover, the present technology provides processors with low power ratings and can be used for continually learning and updating the model on the fly after deploying. The present technology also useful for applications that need to learn on the fly after deployment without retraining the inference network from scratch using cloud servers. It alleviates privacy concerns, network and bandwidth related issues and is ideal for deployment in remote locations and under the sea, inside the body etc. The present technology has the ability to continually learn on edge device after deployment without need of a cloud server and the ability to update the model parameters and adapt to changing environments on the fly after deployment. Further the present technology enables controlling of speed and extent of learning. The present technology enables performing inference on new, unseen data, changing distribution after deployment on edge device. Further the present technology also provides generalized learning method for unseen/untrained object detection, segmentation, classification, or other tasks and has the ability to learn in both low (Integer) and high precision.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims. The scope of the embodiments herein will be ascertained by the claims to be submitted at the time of filing a complete specification.

What is claimed is:

1. A method for device edge learning, the method comprising steps of:
training an artificial intelligence (AI) model for extracting the visual embeddings with pre-trained visual deployment networks;
checking a performance of AI model by feeding real-time data and by performing an inference;
initiating an edge learning, wherein the edge learning refers to an ability of a device to perform inference on items that are not part of an initial training dataset and wherein the edge learning is performed in the background without interfering with the inference;
extracting visual embeddings with pre-trained visual deployment networks;
performing the inference and adding a text image embedding upon obtaining a last layer and an intermediate layer as outputs of inference;
taking the text embeddings using text embedders embeddings;
converting the text to image embeddings to generate augmented image embeddings and adding text embeddings; and
training one or more learning networks on a plurality of agents, wherein the learning networks are adaptable to unseen part of data by mapping with data extracted from other modularities.

2. The method of claim 1, further comprises performing a forward prop with the mapping networks and calculating a loss and a backprop.

3. The method of claim 1, wherein the step of extracting visual embeddings comprises:
taking the visual part of embeddings from seen classes for calculating a loss;
extracting the visual embeddings with pre-trained visual deployment networks, wherein the pre-trained visual deployment networks are divided into the pre-trained networks and semi-supervised networks;
providing the real-time feed to the pre-trained visual deployment networks and the feed displays stock quotes and their respective real-time changes, with a very insignificant lag time;
extracting the image embeddings comprising a last layer and an intermediate layer;
providing one of the real time feeds from different points of view or augmented feeds to a semi-supervised network; and
extracting the image embeddings comprising the last layer and the intermediate layer.

4. The method of claim 1, wherein the step of performing inference further comprises:
computing a dot product of embedding and output vector for doing a maximum of inference;
determining an equivalent class/output; and
obtaining an ensemble of a plurality of outputs.

5. The method of claim 1, wherein the step of taking text embeddings using text embedders embeddings further comprises taking the text embeddings using at least any one of glove embeddings, word to vector embeddings, fast text embeddings and attribute embeddings.

6. The method of claim 1, wherein further comprises augmenting the text embeddings using synonyms if present or by using regex-based text inducers.

7. The method of claim 1, wherein the step of converting the text to image embeddings further comprises converting the pretrained text to image minimalist model trained on minimum context data from unseen images.

8. The method of claim 1, wherein the step of performing forward prop with the mapping networks further comprises:
performing a forward prop with a mapping network;
offloading a first learning network to an agent;
offloading as second learning network to the agent;
offloading a third learning network to the agent;
extracting the features via a graph convolution network (GCN); and
offloading a fourth learning network to the agent.

9. The method of claim 1, wherein the step of calculating loss and backprop further comprises:
calculating the loss based on the equation:
Loss=Z(data_positive)−H(metadata_positive)−lambda*(Z(data_negative)−H(metadata_negative));
where data_positive is input data of the same class from a different camera point of view, the metadata is an input metadata of a different class from different/same cameras, Z is embedding, and H is the learning network;
checking the model;
calculating a contrastive loss and a sync gradient from a plurality of agents upon the model being float;
calculating a regression against the image embeddings at (x);
quantizing the embeddings present in (x) using a minimalistic data upon the model being int;
performing a regression against the quantized image;
calculating a loss and a sync gradient from the plurality of agents;
converting weights and biases to integers.
replacing the softmax with integer softmax; and
replacing contrastive loss with pseudo contrastive loss.

10. A system for a on device edge learning, comprising:
a memory for storing one or more executable modules; and
a processor for executing the one or more executable modules for device edge learning, the one or more executable modules comprising:
a training module for training an artificial intelligence (AI) model for extracting the visual embeddings with pre-trained visual deployment networks;
a checking module for checking the performance of AI model by feeding real-time data and by performing an inference;
an edge learning module for initiating an edge learning, wherein the edge learning refers to an ability of a device to perform inference on items that are not part of an initial training dataset and wherein the edge learning is performed in the background without interfering with the inference;
a visual embedding extraction module for extracting visual embeddings with pre-trained visual deployment networks; and
an inference module for:
performing the inference and adding a text image embedding upon obtaining a last layer and an intermediate layer as outputs of inference;
taking the text embeddings using text embedders embeddings;
converting the text to image embeddings to generate augmented image embeddings and adding text embeddings;
training learning networks on a plurality of agents, wherein the learning networks are adaptable to unseen part of data by mapping with data extracted from other modularities; and
performing a forward prop with the mapping networks and calculating the loss and backprop.

11. The system of claim 10, wherein the visual embeddings extraction module is further configured for:
taking the visual part of the embeddings from one or more seen classes for calculating a loss;
extracting the visual embeddings with pre-trained visual deployment networks, wherein the pre-trained visual deployment networks are divided into the pre-trained networks and semi-supervised networks;
providing the real-time feed to the pre-trained visual deployment networks and the feed displays stock quotes and their respective real-time changes, with an insignificant lag time;
extracting the image embeddings comprising a last layer and an intermediate layer;
providing one of: the real time feed from different point of view or augmented feed to a semi-supervised network; and
extracting the image embeddings comprising the last layer and the intermediate layer.

12. The system of claim 10, wherein the inference module is further configured for:
computing a dot product of embedding and output vector for doing a maximum of inference;
determining an equivalent class/output; and
obtaining an ensemble of a plurality of outputs.

13. The system of claim 10, wherein the inference module if further configured for taking the text embeddings using at least one of: glove embeddings, word to vector embeddings, fast text embeddings and attribute embeddings.

14. The system of claim 10, wherein the inference module is further configured for augmenting the text embeddings using one of: synonyms if present or by using regex-based text inducers.

15. The system of claim 10, wherein the inference module is further configured for converting the pretrained text to image minimalist model trained on minimum context data from unseen images.

16. The system of claim 10, wherein the inference module is further configured for:
performing forward prop with mapping network;
offloading a first learning network to an agent;
offloading as second learning network to the agent;
offloading a third learning network to the agent;
extracting the features via a graph convolution network (GCN); and
offloading a fourth learning network to the agent.

17. The system of claim 10, wherein calculating loss and backprop further comprises:
calculating the loss based on the equation:
Loss=Z(data_positive)−H(metadata_positive)−lambda*(Z(data_negative)−H(metadata_negative))
where data_positive is input data of same class from different camera POV, metadata is an input metadata of different class from different/same cameras, Z is embedding, and H is the learning network;
checking the model;
calculating a contrastive loss and a sync gradient from a plurality of agents upon the model being float;
calculating a regression against the image embeddings at (x);
quantizing the embeddings present in (x) using minimalistic data upon the model being performing regression against the quantized image;
calculating a loss and a sync gradient from the plurality of agents;
converting weights and biases to integers;
replacing the softmax with integer softmax; and
replacing contrastive loss with pseudo contrastive loss.
